(19) United States
(12) Patent Application Publication
(10) Pub. No.: US 2021/0095083 A1
(43) Pub. Date: Apr. 1, 2021

(54) Polyimide Based Film and Display Device Comprising the Same

(71) Applicants: SK Innovation Co., Ltd., Seoul (KR); SK IE Technology Co., Ltd., Seoul (KR)

(72) Inventors: Sang Yoon Park, Daejeon (KR); Hye Ri Kim, Daejeon (KR); Ji Sang Jeong, Daejeon (KR)

(21) Appl. No.: 17/034,990

(22) Filed: Sep. 28, 2020

(30) Foreign Application Priority Data
Sep. 30, 2019 (KR) 10-2019-0120457
Aug. 18, 2020 (KR) 10-2020-0103115

(51) Int. Cl. C08J 5/18; C08G 73/10

(52) U.S. Cl. CPC C08J 5/18; C08J 2379/08; C08G 73/1082

(57) ABSTRACT

Provided are a polyimide-based film and a display device including the same. More particularly, a polyimide-based film having an excellent press characteristic and a display device including the same are provided. As an exemplary embodiment, a polyimide-based film is provided, wherein when a load is applied to a surface of the film with an Erichsen pen, a maximum load satisfies the following Relation 1:

$$0.07 \leq \frac{{F}_{e}}{{T}_{e}} \leq 0.11 \qquad [ Relation 1 ]$$

wherein

Fₑ is a maximum load (N) at which when a load is applied to the surface of the polyimide-based film with the Erichsen pen, the surface is not scratched, and Tₑ is a thickness (μm) of the polyimide-based film.

### CROSS-REFERENCE TO RELATED APPLICATIONS

This application claims priority to Korean Patent Application No. 10-2019-0120457 filed Sep. 30, 2019, and Korean Patent Application No. 10-2020-0103115 filed Aug. 18, 2020, the disclosures of which are hereby incorporated by reference in its entirety.

### TECHNICAL FIELD

The following disclosure relates to a polyimide-based film and a display device including the same. More particularly, the following disclosure relates to a polyimide-based film having an excellent press characteristic and a display device including the same.

### BACKGROUND

Display devices are provided with a cover window which is configured to be transparent on a display panel so that a user may see a display unit from a front of the display panel and includes a polyimide film, in order to protect the display panel from scratches or external shock.

Since the cover window serves to protect a display panel and is a constituent formed on the outermost part of the display device, the cover window should be strong to external shock so that the display panel or the like inside the display device may be protected.

In particular, as the display device is applied to various mobile devices, recently, a structure using a touch panel integrated with a display screen has been widely used instead of a conventional electronic device using an input unit such as a switch or a keyboard separately, and a surface of a cover window is often in contact with a finger or the like as compared with the conventional mobile device, whereby a cover window having a higher strength is required.

Conventionally, a tempered glass for a display was used as a cover window, and is thinner than a regular glass, but is characterized by being manufactured to have high resistance to scratches together with high strength. However, the tempered glass is heavy and is unsuitable for a lighter weight of a portable device such as a mobile device, is vulnerable to external shock, and does not bend more than a certain level, so that it was difficult to apply the tempered glass as a flexible display material.

As such, since the display devices gradually become light-weight, thinner, and flexible, a cover window manufactured from a polymer film having high hardness, high stiffness, and flexibility properties is studied a lot, instead of tempered glass.

Though the flexibility and bendability of the cover window as described above were satisfied, the stiffness thereof was deteriorated, and thus, scratches and a poor pressed appearance occurred.

That is, though various polymer cover window materials for replacing high-priced tempered glass have been diversely developed, development of a cover window satisfying both bending properties and impact resistance is currently needed.

### RELATED ART DOCUMENTS

### Patent Documents

(Patent Document 1) Korean Patent Laid-Open Publication No. 10-2015-0104282

### SUMMARY

An embodiment of the present invention is directed to providing a polyimide-based film having excellent scratch resistance and preventing occurrence of a poor pressed appearance by high strength.

In particular, a polyimide-based film having excellent surface restoring force when external force by a touch pen, a hand, or the like is applied, and a display device including the same is intended to be provided.

Another embodiment of the present invention is directed to providing a polyimide-based film which does not cause a opaque whitening even when a hard coating layer is formed on a film.

In one general aspect, a polyimide-based film is provided, wherein when a load is applied to a surface of the film with an Erichsen pen, a maximum load satisfies the following Relation 1:

$$0.07 \leq \frac{{F}_{e}}{{T}_{e}} \leq 0.11 \qquad [ Relation 1 ]$$

wherein

Fₑ is a maximum load (N) at which when a load is applied to the surface of the polyimide-based film with the Erichsen pen, the surface is not scratched, and Tₑ is a thickness (μm) of the polyimide-based film.

In Relation 1 according to an exemplary embodiment of the present invention, Fₑ may be 2.0 to 6.5 N and Tₑ may be 20 to 100 μm.

According to an exemplary embodiment of the present invention, Fₑ may be 4.0 to 6.0 N.

The polyimide-based film according to an exemplary embodiment of the present invention may have a yellow index of 3.0 or less, as measured in accordance with a standard of ASTM E313.

The polyimide-based film according to an exemplary embodiment of the present invention is obtained by polymerizing a diamine containing an aromatic group and an aromatic diacid chloride beforehand to prepare a polyamide of an amine-terminal polyamide block and then introducing an aromatic dianhydride containing a fluoride-based aromatic dianhydride to prepare a polyamideimide which is produced into a film.

In an exemplary embodiment, polymerization is performed using 0.6 to 0.9 mol of the aromatic diacid dichloride and 0.1 to 0.3 mol of the aromatic dianhydride containing a fluorine-based aromatic dianhydride, based on 1 mol of the diamine containing an aromatic group.

In an exemplary embodiment of the present invention, in the diacid dichloride, terephthaloyl chloride may be used at 80 mol % or more in the total diacid dichloride.

In an exemplary embodiment of the present invention, in the aromatic dianhydride containing a fluorine-based aromatic dianhydride, a content of the fluorine-based aromatic dianhydride may be 30 to 100 mol % of the total aromatic dianhydride.

In another general aspect, a display device includes: a display panel and the polyimide-based film described above formed on the display panel.

Other features and aspects will be apparent from the following detailed description, the drawings, and the claims.

### DETAILED DESCRIPTION OF EMBODIMENTS

Hereinafter, the present invention will be described in more detail with reference to specific examples and exemplary embodiments. However, the following specific examples or exemplary embodiments are only a reference for describing the present invention in detail, and the present invention is not limited thereto, and may be implemented in various forms.

In addition, unless otherwise defined, all technical terms and scientific terms have the same meanings as those commonly understood by a person skilled in the art to which the present invention pertains. The terms used herein are only for effectively describing a certain specific example, and are not intended to limit the present invention.

Throughout the present specification describing the present invention, unless explicitly described to the contrary, “comprising” any elements will be understood to imply further inclusion of other elements rather than the exclusion of any other elements.

In addition, the singular form used in the specification and claims appended thereto may be intended to also include a plural form, unless otherwise indicated in the context.

Among display devices, in particular, a cover window film applied to a smart device is countlessly pressed by a touch pen or a finger nail. Thus, when press resistance is not good, problems such as shortening of a life of a display due to loss or damage of a display surface occur.

Furthermore, when a hard coating layer or the like is formed thereon, a opaque whitening occurs in a lower film by a solvent. Thus, the present inventors found that a polyimide-based film has excellent optical properties so as not to cause the opaque whitening even when the hard coating layer or the like is formed thereon, while having excellent press resistance of a display by external force, may be provided, thereby completing the present invention.

In order to achieve the above object, a polyimide-based film is provided, wherein when a load is applied to a surface of the film with an Erichsen pen, a maximum load satisfies the following Relation 1:

$$0.07 \leq \frac{{F}_{e}}{{T}_{e}} \leq 0.11 \qquad [ Relation 1 ]$$

wherein

Fₑ is a maximum load (N) at which when a load is applied to the surface of the polyimide-based film with the Erichsen pen, the surface is not scratched, and Tₑ is a thickness (μm) of the polyimide-based film.

Preferably, the above Relation 1 may satisfy 0.07 to 0.10.

When Relation 1 is satisfied as described above, the polyimide-based film may have an internal element and module protection performance to replace conventional tempered glass. Furthermore, the polyimide-based film implements a remarkably excellent press characteristic, thereby not causing a press phenomenon by a touch pen or a hand when applied to a cover window film, may further improve impact resistance, and does not cause a opaque whitening even after a hard coating layer is formed thereon. However, Relation 1 is less than 0.07, a press phenomenon by a touch pen or a hand may occur, and Relation 1 is more than 0.11, a opaque whitening may occur when a hard coating layer is formed thereon, in the case in which the polyimide-based film is applied to a flexible cover window film.

By satisfying Relation 1 as described above, the polyimide-based film may implement an excellent press characteristic by the polyimide-based film according to the present invention itself over an overall thickness, not depending on a thickness increase. In particular, when Relation is satisfied, the press characteristic is excellent over an overall thickness range to satisfy all of a lighter weight, a smaller thickness, and flexibility of a display device. Specifically, the polyimide-based film may be appropriately applied to a display device which may prevent a display panel from being deformed by compression when being pressed and is required to have a lighter weight, a smaller thickness, and flexibility.

The polyimide-based film according to the present invention satisfies the press characteristic described above, thereby implementing excellent press resistance and surface restoring force, while preventing damage or loss of a display to be protected to have a life improvement effect.

Preferably, in Relation 1, Fₑ may be 3.0 to 6.5 N and Tₑ may be 25 to 100 μm. More preferably, in Relation 1, Fₑ may be 4.0 to 6.0 N and Tₑ may be 40 to 90 μm.

In the case in which the maximum load and the thickness measured as described above are satisfied, when external force is continuously applied to a display, occurrence of damage and loss to the display due to strong impact is prevented to prevent rapid life shortening of the display. In addition, even when a hard coating layer is formed on the polyimide-based film, a opaque whitening does not occur, so that the polyimide-based film is excellent as a transparent display.

When a load applied to a surface by an Erichsen pen has a high value as described above, the polyimide-based film according to the present invention has excellent press resistance to external force applied by a touch pen, a hand, or the like, and thus, when provided as a cover window film, may more reliably protect a display from loss and damage. Furthermore, the polyimide-based film has excellent surface restoring force by external force to excellently achieve the above effect.

According to an exemplary embodiment of the present invention, the polyimide-based film has different maximum loads measured by an Erichsen pen depending on the thickness as described above, but has an excellent press characteristic over an overall thickness. Thus, when the polyimide-based film is provided as a cover window film, excellent press resistance even by external force applied to a display may be provided to prevent the loss and damage of the display.

According to an exemplary embodiment of the present invention, the polyimide-based film may have a yellow index of 3.0 or less, as measured in accordance with a standard of ASTM E313. Preferably, the yellow index may be 2.9 or less. Specifically, the yellow index may be 1.0 to 3.0, and preferably 1.0 to 2.9. By having the low yellow index as described above, the polyimide-based film may implement excellent optical properties as well as the press characteristic. Here, the yellow index may be measured based on a polyimide-based film having a thickness of 50 μm.

The polyimide-based film according to an exemplary embodiment of the present invention is obtained by polymerizing a diamine containing an aromatic group and an aromatic diacid chloride beforehand to prepare a polyamide of an amine-terminal polyamide block and then introducing an aromatic dianhydride containing a fluoride-based aromatic dianhydride to prepare a polyamideimide which is produced into a film.

In the present invention, polymerization is performed using 0.6 to 0.9 mol of the aromatic diacid dichloride and 0.05 to 0.3 mol of the aromatic dianhydride containing a fluorine-based aromatic dianhydride, based on 1 mol of the diamine containing an aromatic group.

In the present invention, in the diacid dichloride, terephthaloyl chloride may be used at 80 mol % to 100 mol % of the total diacid dichloride.

In the present invention, in the aromatic dianhydride containing a fluorine-based aromatic dianhydride, a content of the fluorine-based aromatic dianhydride may be 30 to 100 mol % of the total aromatic dianhydride.

According to an exemplary embodiment of the present invention, the diamine containing an aromatic group (hereinafter, referred to as an “aromatic diamine”) is not largely limited, but, for example, may be one or more selected from 2,2′-bis(trifluoromethyl)-benzidine (TFMB), bis(3-aminophenyl)sulfone (3DDS), bis(4-aminophenyl)sulfone (ODDS), o-phenylenediamine (o-PDA), p-phenylenediamine (p-PDA), m-phenylenediamine (m-PDA), oxydianiline (ODA), methylenedianiline (MDA), bisaminophenylhexafluoropropane (HFDA), 1,3-bis(4-aminophenoxy)benzene (TPE-R), and the like. In addition, in the present invention, 2,2′-bis(trifluoromethyl)-benzidine (TFMB) is preferred, since when using it, the effect to be desired in the present invention may be obtained better.

According to an exemplary embodiment of the present invention, the fluorine-based aromatic dianhydride is not largely limited, but for example, may include an aromatic dianhydride substituted with a fluorine group unlimitedly such as 4,4′-hexafluoroisopropylidene diphthalic anhydride (6FDA). In addition, the aromatic dianhydride which may be mixed with the fluorine-based aromatic dianhydride is not particularly limited; however, for example, may be one or more selected from 1,2,4,5-benzenetetracarboxylic dianhydride (PMDA), biphenyltetracarboxylic dianhydride (BPDA), benzophenone tetracarboxylic dianhydride (BTDA), 4,4′-oxydiphthalic dianhydride(ODPA), sulfonyl diphthalic anhydride (SO2DPA), (isopropylidenediphenoxy) bis(phthalic anhydride) (6HDBA), 4-(2,5-dioxytetrahydrofuran-3-yl)-1,2,3,4-tetrahydronaphthalene-1,2-dicarboxylic dianhydride(TDA), bis (3,4-dicarboxyphenyl) dimethylsilane dianhydride (SiDA), bisdicarboxylphenoxydiphenyl sulfide dianhydride (BDSDA), and the like, but is not limited thereto.

In the present invention, in the aromatic dianhydride containing a fluorine-based aromatic dianhydride, when a content of the fluorine-based aromatic dianhydride is 30 to 100 mol % of the total aromatic dianhydride, the object of the present invention may be achieved well, and thus, the range is preferred.

In the present invention, the aromatic diacid dichloride includes terephthaloyl dichloride (TPC), and the diacid dichloride which may be mixed and used with the terephthaloyl chloride is not limited as long as it is an aromatic diacid dichloride, but an example thereof may include any one or a mixture of two or more selected from isophthaloyl dichloride (IPC), diphenylether-4,4′-dicarbonyl dichloride (DEDC), 1,1′-biphenyl-4,4′-dicarbonyl dichloride(BPDC), 1,4-naphthalenedicarboxylic dichloride (1,4-NaDC), 2,6-naphthalenedicarboxylic dichloride (2,6-NaDC), 1,5-naphthalenedicarboxylic dichloride (1,5-NaDC), and the like. Preferably, the aromatic diacid dichloride may be one or more selected from terephthaloyl dichloride, isophthaloyl dichloride, and the like.

In the present invention, in the diacid dichloride, terephthaloyl chloride may be used at 80 mol % to 100 mol % in the total diacid dichloride, and when the content of the terephthaloyl chloride is within the range, the press characteristic may be improved, and when both the content and the conditions of oligomer polymerization and heat treatment are satisfied, a better press characteristic may be implemented.

In addition, surprisingly, the polyamideimide according to the present invention may significantly lower the yellow index, and also, may have excellent press resistance and restoring force to external force.

The polyimide-based film of the present invention is obtained by polymerizing an aromatic diamine and an aromatic diacid chloride beforehand to prepare a polyamide of an amine-terminal polyamide block and then introducing an aromatic dianhydride containing a fluoride-based aromatic dianhydride to prepare a polyamic acid, which is imidized to produce the polyamideimide film.

The polyamic acid resin composition may include a polymerization solvent for a solution polymerization reaction, as a solution of the monomers described above. The kind of polymerization solvent is not largely limited, and for example, may be a polar solvent, and specifically, may include one or more polymerization solvents selected from N,N-dimethylacetamide (DMAc), N-methyl-2-pyrrolidone (NMP), dimethylformamide (DMF), dimethylsulfoxide (DMSO), acetone, ethylacetate, and m-cresol, and the like.

According to an exemplary embodiment of the present invention, the polyamic acid resin composition is imidized to obtain a polyamideimide resin.

The imidization may be performed by thermal imidization, chemical imidization, or thermal imidization in combination with chemical imidization. In addition, the imidization may be performed before applying the polyamic acid resin composition to a substrate or after applying the polyamic acid resin composition to a substrate, but is not limited thereto.

Specifically, for example, in the chemical imidization, one or more selected from imidization catalysts and dehydrating agents may be included in the polyamic acid resin composition. Here, as the dehydrating agent, for example, one or more selected from acetic anhydride, phthalic anhydride, maleic anhydride, and the like may be used, and as the imidization catalyst, for example, one or more selected from pyridine, isoquinoline, β-quinoline, and the like may be used, but is not limited thereto.

More preferably, the chemical imidization may be performed by including the imidization catalyst and the dehydrating agent in the polyamic acid resin composition at a temperature of 30 to 70° C. for 20 minutes or more, specifically 30 minutes or more. In addition, by performing the chemical imidization as described above, excellent press resistance and surface restoring force may be secured, and a opaque whitening may not occur even after a hard coating layer is formed on the polyimide-based film. Furthermore, by satisfying Relation 1, the display may be more reliably protected from loss and damage.

Specifically, for example, the thermal imidization may be thermal treatment at 250° C. or higher. Specifically, the heat treatment may be performed at 250 to 350° C. for 1 minute to 2 hours, and preferably, the heat treatment may be performed specifically, at 260 to 350° C. for 30 minutes to 2 hours. When the heat treatment is performed as described above, 99% or more of an imidization degree may be secured, a solvent residual problem may be minimized, and excellent press characteristic and strength may be provided. Furthermore, when the heat treatment is performed in combination with chemical imidization, the physical properties as described above may be further improved. In addition, the thermal imidization may be performed by heating up stepwise at a temperature of 250° C. or lower before heat treatment at 250° C. or higher, but is not limited thereto.

The production method of the present invention may include a first step of reacting an aromatic diamine and an aromatic diacid dichloride to prepare an amide-based oligomer; and a second step of further introducing a dianhydride to the amide-based oligomer to perform a reaction.

When the film is produced by amine-terminal polyamide oligomer polymerization as described above, polymerization reaction uniformity is excellent in spite of an increased polymerization concentration, that is, an increased solid content, and a high press characteristic satisfying Relation 1 may be implemented in addition to excellent optical properties.

Specifically, according to an exemplary embodiment of the present invention, in the first step, the amide-based oligomer may have a molecular weight (formula weight) of 500 to 10,000 g/mol. Preferably, the molecular weight may be 500 to 5,000 g/mol. When the amide-based oligomer has the molecular weight as described above, Relation 1 may be satisfied, surface restoring force by external force may be excellent, and also excellent optical properties may be implemented. In addition, a opaque whitening which occurs after a hard coating layer is formed on the produced polyimide-based film may be prevented.

According to an exemplary embodiment of the present invention, the polyamideimide for producing the polyimide-based film may have a weight average molecular weight of 300,000 to 400,000 g/mol and a polydispersity index (PDI) related to a molecular weight distribution of, unlimitedly, for example, 2.3 to 2.8.

The polyimide-based film according to the present invention is produced from the polyimide or polyamideimide having a uniform and narrow polydispersity index as described above, thereby expressing an excellent press characteristic while achieving overall uniform physical properties of the polyimide-based film. Furthermore, the weight average molecular weight and the polydispersity index may be achieved when the oligomerization method and the conditions of imidization temperature and time as described above are satisfied, and by achieving the properties, safety may be further secured with the excellent press characteristic satisfying Relation 1 and the opaque whitening may be prevented after forming a hard coating layer thereon.

According to an exemplary embodiment of the present invention, the polyimide-based film may have a residual solvent content of 3 wt % or less, based on the total weight of the polyimide-based film. Specifically, the polyimide-based film may have the residual solvent content of 0.01 to 3 wt %, preferably 0.01 to 1 wt %, based on the total weight of the polyimide-based film. Here, the residual solvent content was obtained by measuring a weight change in a section from 150° C. to 370° C. of the polyimide-based film, as measured by thermogravimetric analysis and determining a value obtained by subtracting a weight at 370° C., W₃₇₀ from a weight at 150° C., W₁₅₀ as a residual solvent in the film. By having the residual solvent content as described above, the press characteristic may be significantly improved, and swelling or shrinkage by an external environment does not occur to further improve quality reliability. Furthermore, even after a hard coating layer is formed on the polyimide-based film, the opaque whitening does not occur, so that the polyimide-based film may be applied as a high-quality cover window film.

Another exemplary embodiment of the present invention provides a display device including: a display panel and the polyimide-based film described above formed on the display panel.

According to an exemplary embodiment of the present invention, the display device is not particularly limited as long as it belongs to a field requiring an excellent press characteristic, and may be provided by selecting a display panel appropriate therefor.

Hereinafter, the preferred Examples and Comparative Examples of the present invention will be described. However, the following Examples are only a preferred exemplary embodiment of the present invention, and the present invention is not limited thereto.

The physical properties of the present invention were measured as follows:

(1) Yellow Index

The yellow index of the films produced in the Examples and the Comparative Examples was measured based on a film having a thickness of 50 μm, using a colorimeter (from HunterLab, ColorQuest XE), in accordance with the standard of ASTM E 313.

(2) Weight Average Molecular Weight (Mw) and Polydispersity Index (PDI)

The weight average molecular weight and the polydispersity index of the produced films were measured as follows.

First, a film sample was dissolved in a DMAc eluent containing 0.05 M LiBr and used as a sample.

Measurement was performed by using GPC (Waters GPC system, Waters 1515 isocratic HPLC Pump, Waters 2414 Refractive Index detector), connecting Olexis, polypore, and mixed D columns as a GPC column, using a DMAc solution as a solvent, and using polymethylmethacrylate (PMMA STD, Mw 2,136,000 g/mol) as a standard, and analysis was performed at a flow rate of 1 ml/min at 35° C.

(3) Erichsen Pen Press Characteristic

A film sample which was stored in a constant temperature and humidity room at a temperature of 25° C. and a humidity of 50% for 24 hours or more was placed and fixed on a glass plate, and a scratch of 3 cm or more in a vertical direction was made with a pen manufactured by Erichsen (Hardness Test Pencil Model 318S) having a test lead diameter of 0.75 cm with loads changed stepwise by 0.1 N, and a maximum load value at which scratches did not occur was recorded. After a total of five operations, an average value was rounded off and used as a measurement value.

(4) Measurement of Residual Solvent Content

A value obtained by subtracting a weight at 370° C., W₃₇₀ from a weight at 150° C., W₁₅₀ using TGA (Discovery from TA) was determined as the residual solvent content in the film. Here, measurement conditions were heated up to 400° C. at a heating rate of 30° C./min, and a weight change in a section from 150° C. to 370° C. was measured.

### EXAMPLE 1

Dichloromethane, pyridine, terephthaloyl dichloride (TPC), and 2,2′-bis(trifluoromethyl)-benzidine (TFMB) were added to a reactor under a nitrogen atmosphere, and stirring was performed at 25° C. for 2 hours. Here, a mole ratio of TPC:TFMB was 86:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,670 g/mol.

The oligomer was added to N,N-dimethylacetamide (DMAc) in a reactor under a nitrogen atmosphere and sufficient stirring was performed, and 14 mol of 4,4′-hexafluoroisopropylidene diphthalic anhydride (6FDA) was added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the polyamic acid resin composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 310,000 g/mol and a polydispersity index (PDI) of 2.31. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. The glass substrate was dried at 80° C. for 30 minutes and at 100° C. for 1 hour, heat-treated in a vacuum oven up to 270° C. at a heating rate of 20° C./min for 2 hours, and cooled to room temperature, a film formed on the glass substrate was separated from the substrate to obtain a polyamideimide film having a thickness of 50 μm. The polyamideimide film had a residual solvent content of 0.5 wt %.

### EXAMPLE 2

Dichloromethane, pyridine, terephthaloyl dichloride (TPC), and 2,2′-bis(trifluoromethyl)-benzidine (TFMB) were added to a reactor under a nitrogen atmosphere, and stirring was performed at 25° C. for 2 hours. Here, a mole ratio of TPC:TFMB was 71:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,580 g/mol.

The oligomer was added to N,N-dimethylacetamide (DMAc) in a reactor under a nitrogen atmosphere and sufficient stirring was performed, and 11 mol of 4,4′-hexafluoroisopropylidene diphthalic anhydride (6FDA) and 18 mol of biphenyltetracarboxylic dianhydride (BPDA) were added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 315,000 g/mol and a polydispersity index (PDI) of 2.40. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. Thereafter, the resultant was heat-treated in a vacuum oven up to 270° C. for 1 hour and cooled down to room temperature, and a film formed on the glass substrate was separated from the substrate to obtain a polyamideimide film having a thickness of 50 μm. The polyamideimide film had a residual solvent content of 0.4 wt %.

### EXAMPLE 3

The process was performed in the same manner as in Example 1, except that the polyamideimide film was produced at 80 μm. Here, the polyamideimide film had a residual solvent content of 0.45 wt %.

### EXAMPLE 4

The process was performed in the same manner as in Example 1, except that the polyamideimide film was produced at 30 μm. Here, the polyamideimide film had a residual solvent content of 0.5 wt %.

### EXAMPLE 5

Dichloromethane, pyridine, terephthaloyl dichloride (TPC), 1,1′-biphenyl-4,4′-dicarbonyl dichloride (BPDC), and 2,2′-bis(trifluoromethyl)-benzidine (TFMB) were added to a reactor under a nitrogen atmosphere, and stirring was performed at 25° C. for 2 hours. Here, a mole ratio of TPC:BPDC:TFMB was 67:10:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,580 g/mol.

The oligomer was added to N,N-dimethylacetamide (DMAc) in a reactor under a nitrogen atmosphere and sufficient stirring was performed, and 23 mol of 4,4′-hexafluoroisopropylidene diphthalic anhydride (6FDA) was added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 303,000 g/mol and a polydispersity index (PDI) of 2.35. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. Thereafter, the resultant was heat-treated in a vacuum oven up to 270° C. for 1 hour and cooled down to room temperature, and a film formed on the glass substrate was separated from the substrate to obtain a polyamideimide film having a thickness of 50 μm. The polyamideimide film had a residual solvent content of 0.5 wt %.

### EXAMPLE 6

Dichloromethane, pyridine, terephthaloyl dichloride (TPC), diphenylether-4.4′-dicarbonyl chloride (DEDC), and 2,2′-bis(trifluoromethyl)-benzidine (TFMB) were added to a reactor under a nitrogen atmosphere, and stirring was performed at 25° C. for 2 hours. Here, a mole ratio of TPC:DEDC:TFMB was 68:11:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,520 g/mol.

The oligomer was added to N,N-dimethylacetamide (DMAc) in a reactor under a nitrogen atmosphere and sufficient stirring was performed, and 21 mol of 4,4′-hexafluoroisopropylidene diphthalic anhydride (6FDA) was added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 322,000 g/mol and a polydispersity index (PDI) of 2.26. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. Thereafter, the resultant was heat-treated in a vacuum oven up to 270° C. for 1 hour and cooled down to room temperature, and a film formed on the glass substrate was separated from the substrate to obtain a polyamideimide film having a thickness of 50 μm. The polyamideimide film had a residual solvent content of 0.3 wt %.

### EXAMPLE 7

Dichloromethane, pyridine, terephthaloyl dichloride (TPC), and 2,2′-bis(trifluoromethyl)-benzidine (TFMB) were added to a reactor under a nitrogen atmosphere, and stirring was performed at 25° C. for 2 hours. Here, a mole ratio of TPC:TFMB was 75:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,610 g/mol.

The oligomer was added to N,N-dimethylacetamide (DMAc) in a reactor under a nitrogen atmosphere and sufficient stirring was performed, and 16 mol of 4,4′-hexafluoroisopropylidene diphthalic anhydride (6FDA) and 9 mol of biphenyltetracarboxylic dianhydride (BPDA) were added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 311,000 g/mol and a polydispersity index (PDI) of 2.33. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. Thereafter, the resultant was heat-treated in a vacuum oven up to 270° C. for 1 hour and cooled down to room temperature, and a film formed on the glass substrate was separated from the substrate to obtain a polyamideimide film having a thickness of 50 μm. The polyamideimide film had a residual solvent content of 0.4 wt %.

### EXAMPLE 8

Dichloromethane, pyridine, terephthaloyl dichloride (TPC), isophthaloyl dichloride (IPC), and 2,2′-bis(trifluoromethyl)-benzidine (TFMB) were added to a reactor under a nitrogen atmosphere, and stirring was performed at 25° C. for 2 hours. Here, a mole ratio of TPC:IPC:TFMB was 75:10:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,610 g/mol.

The oligomer was added to N,N-dimethylacetamide (DMAc) in a reactor under a nitrogen atmosphere and sufficient stirring was performed, and 15 mol of 4,4′-hexafluoroisopropylidene diphthalic anhydride (6FDA) was added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the polyamic acid resin composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 340,000 g/mol and a polydispersity index (PDI) of 2.42. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. The glass substrate was dried at 80° C. for 30 minutes and at 100° C. for 1 hour, heat-treated in a vacuum oven up to 270° C. at a heating rate of 20° C./min for 2 hours, and cooled to room temperature, a film formed on the glass substrate was separated from the substrate to obtain a polyamideimide film having a thickness of 50 μm. The polyamideimide film had a residual solvent content of 0.5 wt %.

### COMPARATIVE EXAMPLE 1

Dichloromethane and 2,2′-bis(trifluoromethyl)-benzidine (TFMB) were added to a reactor under a nitrogen atmosphere and sufficiently stirred, 4.4′-hexafluoroisopropylidene diphthalic anhydride (6FDA) was added and sufficiently stirred until the materials were dissolved, and terephthaloyl dichloride (TPC) was added and stirred at 25° C. for 6 hours to perform dissolution and the reaction, thereby preparing a polyamic acid resin composition. Here, an amount of each monomer was such that a mole ratio of TFMB:6FDA:TPC was 100:14:86, as shown in the composition ratio of Table 1, and a solid content was adjusted to 6.5 wt %, and a temperature of the reactor was maintained at 30° C. Subsequently, Pyridine and acetic anhydride were added to the solution at 2.5-fold of the total dianhydride, and stirring was performed at 60° C. for 1 hour.

Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 245,000 g/mol and a polydispersity index (PDI) of 3.2. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. The glass substrate was dried at 80° C. for 30 minutes and at 100° C. for 1 hour, heat-treated in a vacuum oven up to 270° C. at a heating rate of 20° C./min for 2 hours, and cooled to room temperature, a film formed on the glass substrate was separated from the substrate to obtain a polyamideimide film having a thickness of 50 μm. The polyamideimide film had a residual solvent content of 0.5 wt %.

### COMPARATIVE EXAMPLE 2

The process was performed in the same manner as in Comparative Example 1, except that the polyamideimide film was produced at 30 μm. Here, the polyamideimide film had a residual solvent content of 0.5 wt %.

### COMPARATIVE EXAMPLE 3

The process was performed in the same manner as in Comparative Example 1, except that the polyamideimide film was produced at 80 μm. Here, the polyamideimide film had a residual solvent content of 0.6 wt %.

### COMPARATIVE EXAMPLE 4

The composition for forming a polyimide-based film obtained in Example 1 was subjected to solution casting on a glass substrate using an applicator bar coating method. The glass substrate was dried at 80° C. for 30 minutes and at 100° C. for 1 hour, heat-treated in a vacuum oven up to 240° C. at a heating rate of 20° C./min for 30 minutes, and cooled to room temperature, a film formed on the glass substrate was separated from the substrate to obtain a polyamideimide film having a thickness of 50 μm. The polyamideimide film had a residual solvent content of 3.2 wt %.

### COMPARATIVE EXAMPLE 5

The process was performed in the same manner as in Comparative Example 4, except that the polyamideimide film was produced at 30 μm. Here, the polyamideimide film had a residual solvent content of 3.1 wt %.

### COMPARATIVE EXAMPLE 6

The process was performed in the same manner as in Comparative Example 4, except that the polyamideimide film was produced at 80 μm. Here, the polyamideimide film had a residual solvent content of 3.2 wt %.

### COMPARATIVE EXAMPLE 7

Dichloromethane, pyridine, terephthaloyl dichloride (TPC), isophthaloyl dichloride (IPC), and 2,2′-bis(trifluoromethyl)-benzidine (TFMB) were added to a reactor under a nitrogen atmosphere, and stirring was performed at 25° C. for 2 hours. Here, a mole ratio of TPC:IPC:TFMB was 20:50:100, and a solid content was adjusted to 10 wt %.

Thereafter, the reactant was precipitated in an excessive amount of methanol and filtered to obtain a solid content, which was dried at 50° C. for 6 hours or more under vacuum to obtain an amide-based oligomer, and the prepared amide-based oligomer had a formula weight (FW) of 1,410 g/mol.

The oligomer was added to N,N-dimethylacetamide (DMAc) in a reactor under a nitrogen atmosphere and sufficient stirring was performed, and 20 mol of 4,4′-hexafluoroisopropylidene diphthalic anhydride (6FDA) was added based on 100 mol of TFMB and sufficient stirring was performed to perform dissolution and the reaction until the materials were dissolved, thereby preparing a polyamic acid resin composition. Each monomer was adjusted to have a solid content of 6.5 wt %. Pyridine and acetic anhydride were added to the polyamic acid resin composition at 2.5-fold of the total moles of the dianhydride, and stirring was performed at 60° C. for 1 hour. Thereafter, the solution was precipitated in an excessive amount of methanol and then filtered to obtain a solid content, which was dried under vacuum at 50° C. for 6 hours or more to obtain polyamideimide powder. Here, the polyamideimide had a weight average molecular weight of 300,000 g/mol and a polydispersity index (PDI) of 2.52. The polyamideimide powder was diluted and dissolved at 20 wt % in DMAc to prepare a composition for forming a polyimide-based film.

The obtained composition for forming a polyimide-based film was subjected to solution casting on a glass substrate using an applicator bar coating method. The glass substrate was dried at 80° C. for 30 minutes and at 100° C. for 1 hour, heat-treated in a vacuum oven up to 270° C. at a heating rate of 20° C./min for 2 hours, and cooled to room temperature, a film formed on the glass substrate was separated from the substrate to obtain a polyamideimide film having a thickness of 50 μm. The polyamideimide film had a residual solvent content of 0.6 wt %.

### COMPARATIVE EXAMPLE 8

A polyamideimide film having a thickness of 50 μm was obtained in the same manner as in Example 1, except that the same content of cyclobutanetetracarboxylic dianhydride (CBDA) was used instead of 4,4′-hexafluoroisopropylidene diphthalic anhydride (6FDA). The polyamideimide film had a residual solvent content of 0.5 wt %.

### COMPARATIVE EXAMPLE 9

A polyamideimide film having a thickness of 50 μm was obtained in the same manner as in Example 1, except that 7 mol of 4,4′-hexafluoroisopropylidene diphthalic anhydride (6FDA) and 7 mol of cyclobutanetetracarboxylic dianhydride (CBDA) were used. The polyamideimide film had a residual solvent content of 0.5 wt %.

The physical properties (yellow index and press characteristic) of the polyamideimide films produced in Examples to 8 and Comparative Examples 1 to 9 were measured and are shown in the following Table 1. In addition, a hard coating composition was applied on the polyamideimide film using a #18 Mayer Bar, dried at 60° C. for 5 minutes, irradiated with UV at 1 J/cm² using a high pressure metal lamp, and cured at 120° C. for 15 minutes to form a hard coating layer having a thickness of 10 μm, and it was visually confirmed whether a opaque whitening occurs, which is shown in the following Table 1.

∘: occurrence of opaque whitening

×: no opaque whitening

[Preparation of Composition for Forming Hard Coating Layer]

2-(3,4-Epoxycyclohexyl)ethyltrimethoxysilane (ECTMS, TCI) and water were mixed at a ratio of 24.64 g: 2.70 g (0.1 mol: 0.15 mol) to prepare a reaction solution and placed into a 250 ml 2-neck flask. 0.1 mL of a tetramethylammonium hydroxide catalyst (Aldrich) and 100 mL of tetrahydrofuran (Aldrich) were added to the mixture and stirring was performed at 25° C. for 36 hours. Thereafter, layer separation was performed, a product layer was extracted with methylene chloride (Aldrich), moisture was removed from the extract with magnesium sulfate (Aldrich), and the solvent was dried under vacuum to obtain an epoxy siloxane-based resin. As a result of measuring the epoxy siloxane-based resin using gel permeation chromatography (GPC), a weight average molecular weight was 2,500 g/mol.

A composition in which 30 g of the epoxy siloxane-based resin as prepared above, 10 g of (3′,4′-epoxycyclohexyl)methyl 3,4-epoxycyclohexanecarboxylate and 5 g of bis[(3,4-epoxycyclohexyl)methyl]adipate as a crosslinking agent, 0.5 g of (4-methylphenyl)[4-(2-methylpropyl)phenyl]iodoniumhexafluorophosphate as a photoinitiator, and 54.5 g of methylethyl ketone were mixed was prepared.

TABLE 1

| | | Erichsen pen | Opaque whitening after |
|---|---|---|---|
| | | press | forming a hard coating |
| | Yellow index | characteristic | layer |
| Example 1 | 2.0 | 4.5 | × |
| Example 2 | 2.1 | 4.5 | × |
| Example 3 | 2.0 | 6.0 | × |
| Example 4 | 2.0 | 2.5 | × |
| Example 5 | 1.9 | 4.5 | × |
| Example 6 | 1.8 | 4.3 | × |
| Example 7 | 1.9 | 4.6 | × |
| Example 8 | 2.0 | 4.4 | × |
| Comparative | 3.1 | 2.5 | ○ |
| Example 1 | | | |
| Comparative | 3.3 | 1.5 | ○ |
| Example 2 | | | |
| Comparative | 3.2 | 5.0 | ○ |
| Example 3 | | | |
| Comparative | 3.5 | 3.0 | ○ |
| Example 4 | | | |
| Comparative | 3.3 | 2.0 | ○ |
| Example 5 | | | |
| Comparative | 3.2 | 4.5 | ○ |
| Example 6 | | | |
| Comparative | 2.9 | 3.0 | ○ |
| Example 7 | | | |
| Comparative | 4.0 | 1.8 | ○ |
| Example 8 | | | |
| Comparative | 3.1 | 1.7 | ○ |
| Example 9 | | | |

As shown in the above Table 1, the polyimide-based film according to the present invention had a maximum load satisfying Relation 1 when a load was applied to the surface with the Erichsen pen, thereby having excellent scratch resistance and strength, and was able to prevent poor appearance with excellent surface restoring force when external force such as press was applied. In addition, the polyimide-based film had an excellent press characteristic and does not cause a opaque whitening even when the hard coating layer was formed thereon, and thus, was excellent for being applied to a transparent display. Furthermore, the polyimide-based film satisfied a terephthaloyl dichloride content of 60 to 80 mol based on 100 mol of a diamine, was produced by oligomer polymerization of two steps or more, and implemented the press characteristic satisfying Relation 1, when a heat treatment was performed under a condition of a temperature of 250° C. or higher for 30 minutes or more, and thus, may achieve the physical properties to be desired.

Thus, the polyimide-based film according to the present invention has excellent optical properties while having excellent press resistance of a display by external force, and thus, may provide a display device preventing occurrence of poor appearance.

The polyimide-based film according to the present invention has excellent scratch resistance and strength, thereby capable of preventing poor appearance due to being pressed by external force.

In particular, the polyimide-based film is provided as a cover window film and a display device, and thus, may be applied to various display fields requiring a press characteristic, such as smart devices.

Since polyimide-based film according to the present invention has excellent optical properties, does not produce a opaque whitening even when a hard coating layer is formed thereon, and has excellent surface restoring force when external force such as press is applied thereto, the polyimide-based film is excellent as a cover window film material and a display device including the same.

Hereinabove, although the present invention has been described by the specific matters and specific exemplary embodiments, they have been provided only for assisting in the entire understanding of the present invention. Therefore, the present invention is not limited to the exemplary embodiments, and various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

What is claimed is:

1. A polyimide-based film, wherein when a load is applied to a surface of the film with an Erichsen pen, a maximum load satisfies the following Relation 1:
$$0.07 \leq \frac{{F}_{e}}{{T}_{e}} \leq 0.11 \qquad [ Relation 1 ]$$
wherein
Fₑ is a maximum load (N) at which when a load is applied to the surface of the polyimide-based film with the Erichsen pen, the surface is not scratched, and Tₑ is a thickness (μm) of the polyimide-based film.

2. The polyimide-based film of claim 1, wherein in Relation 1, Fₑ is 2.0 to 6.5 N and Tₑ is 20 to 100 μm.

3. The polyimide-based film of claim 2, wherein Fₑ is 4.0 to 6.0 N.

4. The polyimide-based film of claim 1, wherein a yellow index is 3.0 or less, as measured in accordance with a standard of ASTM E313.

5. The polyimide-based film of claim 1, wherein a content of terephthaloyl dichloride is 60 to 80 mol, based on 100 mol of a diamine.

6. The polyimide-based film of claim 1, wherein a content of biphenyltetracarboxylic dianhydride is 5 to 20 mol, based on 100 mol of a diamine.

7. A display device comprising: a display panel and the polyimide-based film of claim 1 formed on the display panel.
